(19) United States
(12) Patent Application Publication
(10) Pub. No.: US 2021/0240767 A1
(43) Pub. Date: Aug. 5, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Dai TAKESHIMA, Kanagawa (JP); Masato ANDO, Kanagawa (JP)

(73) Assignee: FUJI XEROX CO., LTD., Tokyo (JP)

(21) Appl. No.: 16/941,559

(22) Filed: Jul. 29, 2020

(30) Foreign Application Priority Data
Jan. 30, 2020 (JP) 2020-013308

(51) Int. Cl. G06F 16/904; G06F 16/901; G06F 16/9032; G06F 16/906

(52) U.S. Cl. CPC G06F 16/904; G06F 16/906; G06F 16/90332; G06F 16/901

(57) ABSTRACT

An information processing apparatus includes a processor. The processer is configured to receive input of a given keyword, and arrange and present plural words or phrases around the keyword, the words or phrases being related to the keyword, on the basis of content indicated by an existing relation diagram or information about the keyword, the relation diagram including plural items having relations and being generated in advance by systematically connecting the items.

### CROSS-REFERENCE TO RELATED APPLICATIONS

This application is based on and claims priority under 35 USC 119 from Japanese Patent Application No. 2020-013308 filed Jan. 30, 2020.

### BACKGROUND

### (i) Technical Field

The present disclosure relates to an information processing apparatus and a non-transitory computer readable medium.

### (ii) Related Art

Japanese Unexamined Patent Application Publication No. 2016-081185 describes a disclosure of an information processing apparatus. The information processing apparatus includes an acceptance unit, a deployment unit, and an output unit. A relation diagram is created by systematically connecting plural function items in accordance with dependence relations of the function items, each of the plural function items representing a function related to quality function deployment. Among the plural function items, a function item representing a function belonging to any of plural processes in the quality function deployment is provided with attribute information for identifying the process to which the function item belongs. Upon the relation diagram being input, the acceptance unit extracts, from the relation diagram, information for identifying the function item, the attribute information provided for the function item, and dependence information for identifying the dependence relations between the function items and accepts them as raw information. The deployment unit classifies the function items according to the process on the basis of the attribute information in the raw information, creates deployment information used for deploying the classified function items for each process, and deploys, on the basis of the deployment information, the raw information into a deployment chart in which the function items are deployed and in which the processes are axes. The output unit outputs the deployment chart deployed by the deployment unit.

### SUMMARY

Generation of a relation diagram formed by connecting plural items representing events by using logical relations needs experience of generating a relation diagram or expertise in events. It is difficult for a user who is inexperienced in generating a relation diagram or who has little expertise to generate a relation diagram.

Aspects of non-limiting embodiments of the present disclosure relate to an information processing apparatus and a non-transitory computer readable medium enables presentation of information for supporting conception of items to be arranged in a relation diagram so that even a user who is inexperienced in generating a relation diagram or who has little expertise may generate a relation diagram.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor. The processer is configured to receive input of a given keyword, and arrange and present plural words or phrases around the keyword, the words or phrases being related to the keyword, on the basis of content indicated by an existing relation diagram or information about the keyword, the relation diagram including plural items having relations and being generated in advance by systematically connecting the items.

### BRIEF DESCRIPTION OF THE DRAWINGS

An exemplary embodiment of the present disclosure will be described in detail based on the following figures, wherein:

FIG. 1 schematically illustrates a configuration of an information processing system according to the exemplary embodiment;

FIG. 2 is a block diagram illustrating a hardware configuration of a server;

FIG. 3 is a block diagram illustrating an example of a functional configuration of the server;

FIG. 4 illustrates a data structure example of a relation diagram information table;

FIG. 5 illustrates a data structure example of an item information table;

FIG. 6 illustrates a data structure example of a relation line information table;

FIG. 7 is a flowchart illustrating a flow of a words or phrases presenting process performed by the server;

FIG. 8 illustrates an example of a user interface provided by the server;

FIG. 9 illustrates an example of the user interface provided by the server;

FIG. 10 illustrates an example of information to be used for calculating scores; and

FIG. 11 illustrates an example of the user interface provided by the server.

### DETAILED DESCRIPTION

Hereinafter, an example of an exemplary embodiment of the present disclosure will be described with reference to the attached drawings. Note that identical or equivalent components and sections are denoted by the same reference numerals in the drawings. In addition, the dimensional ratios in the drawings may be different from the actual ratios by being exaggerated for convenience of description.

First, the background to the exemplary embodiment of the present disclosure that the inventors have arrived at will be described.

Typically, in a system using complex physical phenomena, many events are linked to each other in a chained manner. For example, an effect, such as a final quality of a product, may be caused by plural events, which are caused by plural other events, and the plural other events are caused by plural still other events. In such a complex system, a large number of qualities need to be assured, and cause-and-effect relations between designs and qualities are extremely complex. Accordingly, it is difficult to find a design item that assures a desired quality, and a change in design value for assuring a certain quality may tend to adversely affect the other qualities.

To visualize and organize such complex cause-and-effect relations, relation information is used. The relation information refers to information in which causes and cause-and-effect relations between the causes are defined. An example of a method for representing the relation information is a relation diagram representing logical relations by connecting items representing events serving as effects and items representing events serving as their causes to each other via relation lines. An example of the relation diagram is a logic tree. The relation diagram is suitably used to indicate items representing events serving as effects and items representing events serving as their causes in detail without any missing or overlapping item.

Another example of a method for representing the relation information is a quality function deployment chart representing relations between events listed on plural axes that intersect with each other, by using symbols or numeric values arranged in a matrix. The quality function deployment chart represents relations between events arranged on plural axes in a matrix in which some events are extracted from among many events and arranged on axes. Thus, relations between many item representing events serving as effects and many item representing events serving as causes may be represented simply.

However, if a relation diagram includes too many items representing target events, the diagram becomes excessively complex and large. In addition, the quality function deployment chart is incapable of representing detailed relations including events that are not arranged on axes, and as a result, items tend to be missing.

In a typical, widely used quality function deployment chart, items representing events serving as causes and items representing events serving as effects are arranged on two axes, the horizontal axis and the vertical axis. Thus, it is difficult to represent information about the reasons for the indicated relations. However, it is useful to use a multi-axis quality function deployment chart representing overall relations between events in which three or more axes are arranged to intersect with one another and some events are extracted and illustrated from among the events constituting the relations.

From the above description, by using both a relation diagram and a multi-axis quality function deployment chart, it is possible to extract and illustrate relations between plural events in detail without any missing or overlapping item, while simply displaying the relations between many events. However, it is complicated to convert a relation diagram into a multi-axis quality function deployment chart or to convert a multi-axis quality function deployment chart into a relation diagram, and a system that supports the conversion is necessary.

In a case where a two-axis quality function deployment chart is to be displayed by depicting a relation diagram having hierarchical relations between plural events and selecting a level therefrom, in order to generate a hierarchical relation diagram, the relations between plural events need to be originally organized in a hierarchical manner. Unless the relations between plural events are originally organized in a hierarchical manner, it is difficult to depict hierarchical relations between events in detail without any missing or overlapping item, which is the purpose of the disclosure.

The disclosure disclosed in Japanese Unexamined Patent Application Publication No. 2016-081185 proposes deployment of a quality function deployment chart after selecting an event corresponding to each axis of the quality function deployment chart on a generated relation diagram. In this technique, however, information of the relation diagram is condensed to generate a quality function deployment chart. This decreases information of the quality function deployment chart much less than information of the relation diagram. Thus, although it is possible to generate the quality function deployment chart from the relation diagram, it is difficult in turn to reflect any changes of the quality function deployment chart in the relation diagram.

As described above, the relation diagram and the quality function deployment chart have different roles to visualize the same information defining relations between plural events. Accordingly, it is desired, not only to use either one or to convert either one into the other in one way, but also to generate and view both back and forth while keeping all information of complex relations between events.

However, generation of a relation diagram formed by connecting plural items representing events by using logical relations needs experience of generating a relation diagram or expertise in events. It is difficult for a user who is inexperienced in generating a relation diagram or who has little expertise to generate a relation diagram.

The exemplary embodiment provides a method for presenting information for supporting conception of items representing events to be arranged in a relation diagram so that even a user who is inexperienced in generating a relation diagram or who has little expertise may generate a relation diagram efficiently.

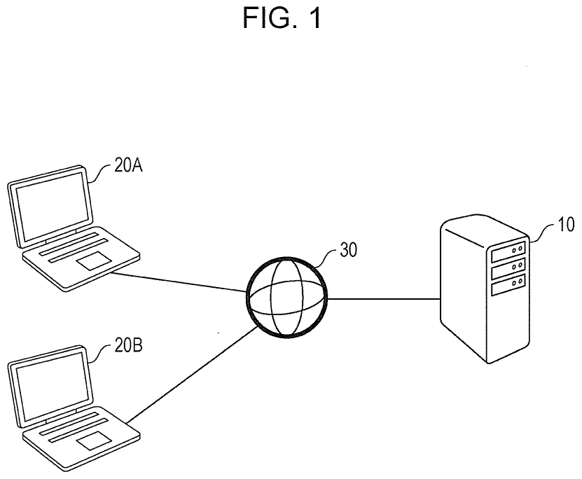

FIG. 1 schematically illustrates a configuration of an information processing system according to the exemplary embodiment. FIG. 1 illustrates a server 10 as an information processing apparatus and user terminals 20A and 20B.

The server 10 is an apparatus that outputs a relation diagram illustrating relations between items representing plural events. The relation diagram represents relations by linking items via lines. The server 10 may represent, as a relation between plural events, a logical relation between events, a relation between an event serving as a cause and an event serving as its effect, a dependence relation between events, or the like. In the exemplary embodiment, the server 10 has functions of receiving input regarding generation of relation diagrams from the user terminals 20A and 20B and generating relation diagrams in accordance with the received input. The user terminals 20A and 20B may receive the input regarding generation of different relation diagrams from users. In the exemplary embodiment, the server 10 extracts words or phrases related to a keyword that is received from the user terminals 20A and 20B. The server 10 then generates visual information for presenting the extracted words or phrases to the user terminals 20A and 20B. For example, as the visual information, the server 10 generates a user interface to be presented to the user terminals 20A and 20B.

The exemplary embodiment is applicable to a relation diagram generating process for performing processing to obtain a relation diagram in quality function deployment. For example, in designing a product or a service, a design quality that satisfies customers is set, and in order to embody the set design quality, quality function deployment is applied to checking of relations with the items or components. In quality function deployment, it is necessary to check actual relations properly, and thus, in quality function deployment, many items such as a design quality are set accurately without any missing item (without any omission). In addition, in quality function deployment, one or more processes among a series of related processes are arranged on axes, items of the processes are displayed systematically in a hierarchical manner, and thereby correspondence relations between the items are clarified.

The exemplary embodiment is applied to generation of a relation diagram representing correspondence relations (dependence relations) between items in two processes by combining correspondence relations between two related processes (e.g., correspondence relations in a deployment chart in which processes are arranged on axes) for quality function deployment of various cases. The generated relation diagram may be deployed as a two-element chart in quality function deployment. The two-element chart in quality function deployment may be any of various charts, such as a required quality deployment chart, a quality element (characteristics) deployment chart, a planned quality setting chart, a design quality setting chart, a function deployment chart, a mechanism deployment chart, a unit/component deployment chart, a method deployment chart, a new idea deployment chart, and a cost deployment chart. The two-element chart may further be any of various charts, such as a cost plan setting chart, a material deployment chart, a fault tree (FT) deployment chart, a reliability plan setting chart, a measurement equipment deployment chart, a measurement method deployment chart, a business function deployment chart, a technique deployment chart, a quality assurance (QA) chart, a quality control (QC) step chart, and an assured item deployment chart. The relation diagram generated according to the exemplary embodiment may be deployed as any of these charts. Without limitation to the above, the relation diagram generated according to the exemplary embodiment may be used for generating a two-element chart representing correspondence relations between desired processes.

Furthermore, the relation diagram generated according to the exemplary embodiment is applied to generation of a diagram for quality function deployment representing correspondence relations between items in each process by combining correspondence relations between, not only two processes, but also three or more (e.g., three or four) processes. Note that in the following description, a diagram for quality function deployment representing correspondence relations between plural processes will be referred to as “multi-element chart”. That is, in the following description, a multi-element chart representing correspondence relations between two processes is referred to as a two-element chart, a multi-element chart representing correspondence relations between three processes is referred to as a three-element chart, and a multi-element chart representing correspondence relations between four processes is referred to as a four-element chart. In addition, in the exemplary embodiment, a process refers to a series of actions that relate to or act on each other for a target event, such as quality-performance-structure-material. Between related processes, an output of a process serves as an input for another (see, for example, JIS Q 9000).

Each of the user terminals 20A and 20B is an apparatus that is connected to the server 10 via a network 30, such as the Internet or an intranet, to receive input regarding generation of a relation diagram from a user. The user terminals 20A and 20B are used by different users. Although FIG. 1 illustrates two user terminals, the number of user terminals is not limited to a particular number in the information processing system. Each user terminal may be any apparatus having a function to be connected to the network 30, such as a personal computer, a smartphone, or a tablet terminal. In the following description, unless it is necessary to distinguish the user terminals 20A and 20B from each other, the user terminals 20A and 20B will be simply referred to as a user terminal 20.

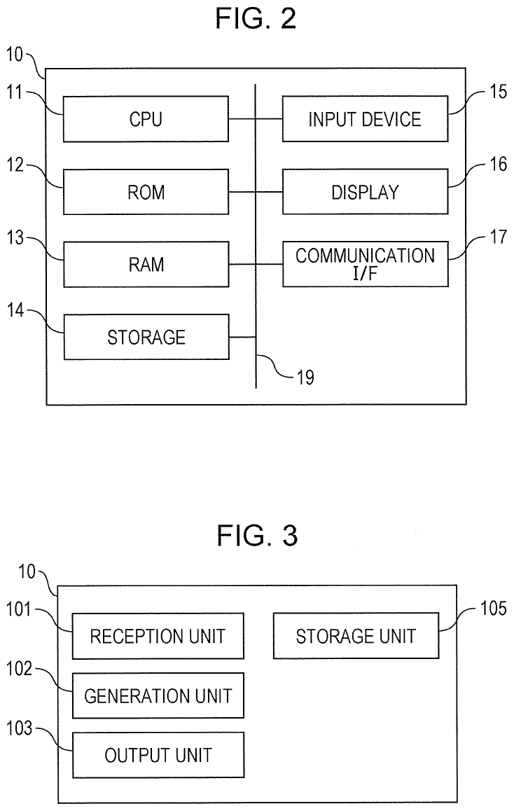

FIG. 2 is a block diagram illustrating a hardware configuration of the server 10.

As illustrated in FIG. 2, the server 10 includes a central processing unit (CPU) 11, a read only memory (ROM) 12, a random access memory (RAM) 13, a storage 14, an input device 15, a display 16, and a communication interface (I/F) 17. The components are connected to each other via a bus 19 to be able to communicate with each other.

The CPU 11 executes various programs or controls each unit. That is, the CPU 11 reads a program from the ROM 12 or the storage 14 and executes the program by using the RAM 13 as a work area. In accordance with the program recorded on the ROM 12 or the storage 14, the CPU 11 controls the above components and performs various arithmetic processes. In the exemplary embodiment, the ROM 12 or the storage 14 stores a words or phrases presenting program for extracting words or phrases related to a keyword that is input by a user and presenting the extracted words or phrases to a user terminal 20.

The ROM 12 stores various programs and various kinds of data. The RAM 13 temporarily stores a program or data as a work area. The storage 14 is constituted by a storage device such as a hard disk drive (HDD), a solid state drive (SSD), or a flash memory, and stores various programs including an operating system and various kinds of data.

The input device 15 includes a pointing device, such as a mouse, and a keyboard and is used by a user to input various kinds of information.

The display 16 is, for example, a liquid crystal display and displays various kinds of information. The display 16 may also function as the input device 15 by employing a touch panel.

The communication interface 17 is an interface for communicating with other equipment such as a user terminal 20, and for example, a standard such as Ethernet (registered trademark), Fiber Distributed Data Interface (FDDI), or Wi-Fi (registered trademark) is used.

When executing the above relation diagram presenting program, the server 10 implements various functions by using the above hardware resources. The functional configuration implemented by the server 10 will be described.

Next, the functional configuration of the server 10 will be described.

FIG. 3 is a block diagram illustrating an example of the functional configuration of the server 10.

As illustrated in FIG. 3, as the functional configuration, the server 10 includes a reception unit 101, a generation unit 102, an output unit 103, and a storage unit 105. Each function is implemented by the CPU 11 reading and executing the words or phrases presenting program stored in the ROM 12 or the storage 14.

The reception unit 101 receives input regarding generation of a relation diagram from a user from a user terminal 20. The input regarding generation of a relation diagram includes various inputs regarding generation of a relation diagram such as setting of items, setting of attribute information for the items, linking between the items, and setting of processes for the items. The server 10 displays a user interface for generating a relation diagram on a screen of a user terminal 20. Information of a relation diagram, items, and relation lines is generated on the user interface of the user terminal 20 by a user operating keys on the keyboard, the mouse, or the like, and the reception unit 101 receives the information. In addition to reception of such information generated by the user operating keys on the keyboard or the like, the reception unit 101 may also, for example, read information stored in a hard disk (including, in addition to one built in a computer, one connected via a network).

In the exemplary embodiment, the reception unit 101 receives, from a user terminal 20, input of a given keyword. The given keyword is, for example, a word or phrase serving as a start point when a user generates a relation diagram. The given keyword is input by a user who operates a user terminal 20 in a state where a user interface for presenting words or phrases related to the keyword input from the user terminal 20 is presented on the user terminal 20. Examples of the user interface for presenting words or phrases will be described later.

The generation unit 102 generates a relation diagram on the basis of the input received by the reception unit 101. The relation diagram is generated on the basis of information received by the reception unit 101. For example, in accordance with a user editing operation received by the reception unit 101, the generation unit 102 edits items (including addition, deletion, and the like), edits attributes of the items (e.g., item names, characteristics, and the like), rearranges relation lines (including addition, deletion, and the like), and edits attributes of the relation lines (e.g., strength, direction, and the like). In addition, in accordance with a user operation on a screen displayed by the output unit 103, the generation unit 102 displays a new item and another item at different positions separately or at the same position in an integrated manner. The other item has substantially the same attributes as the new item and is already present at a position different from the position of the new item in a relation diagram.

In the exemplary embodiment, the generation unit 102 also extracts words or phrases related to the keyword that is input to and received by the reception unit 101, on the basis of a relation diagram generated in the past or information about the keyword. The information about the keyword is, for example, information obtained by analyzing document data on the Internet.

For example, a user inputs a keyword “pot” to a user terminal 20. On the basis of a relation diagram generated in the past or information about the keyword, the generation unit 102 extracts words or phrases related to “pot” that is input.

Subsequently, the generation unit 102 generates visual information in which the extracted words or phrases are arranged around the keyword that is input to and received by the reception unit 101. As the visual information, for example, the generation unit 102 generates a user interface to be presented to a user terminal 20. Examples of the visual information generated by the generation unit 102 will be described later in detail.

The output unit 103 outputs the relation diagram generated by the generation unit 102. The relation diagram is output to the user terminal 20 that has received input regarding generation of a relation diagram from a user. In addition, the output unit 103 stores information about the relation diagram generated by the generation unit 102 in the storage unit 105.

In the exemplary embodiment, the output unit 103 outputs the visual information in which the extracted words or phrases are arranged around the keyword that is input to and received by the reception unit 101. Then, the reception unit 101 receives input for the visual information that is output from the output unit 103.

The storage unit 105 stores various kinds of information about operations of the server 10. In the exemplary embodiment, the storage unit 105 stores information about a relation diagram. For example, the storage unit 105 stores a relation diagram information table, an item information table, and a relation line information table. Herein, examples of the information about a relation diagram stored in the storage unit 105 will be described.

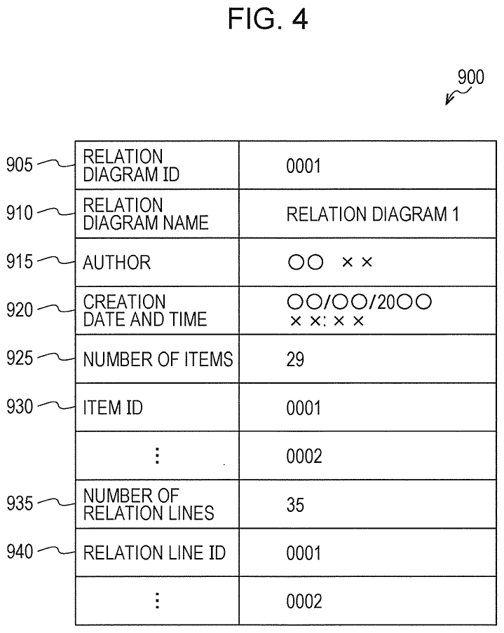

FIG. 4 illustrates a data structure example of a relation diagram information table 900. The relation diagram information table 900 includes a relation diagram identifier (ID) cell 905, a relation diagram name cell 910, an author cell 915, a generation date and time cell 920, a number-of-items cell 925, item ID cells 930, a number-of-relation-lines cell 935, and relation line ID cells 940. In the exemplary embodiment, the relation diagram ID cell 905 stores information (relation diagram ID) for uniquely identifying a relation diagram. The relation diagram name cell 910 stores a name of the relation diagram having the relation diagram ID. The author cell 915 stores an author of the relation diagram. The generation date and time cell 920 stores a date and time at which the relation diagram is generated or edited (year, month, day, hour, minute, second, decimal, or a combination thereof). The number-of-items cell 925 stores the number of items in the relation diagram. There are as many item ID cells 930 as the number of items indicated in the number-of-items cell 925 below the number-of-items cell 925. In the exemplary embodiment, the item ID cells 930 store information (item IDs) for uniquely identifying the items. The information indicated by the item IDs is stored in an item information table 1000. The number-of-relation-lines cell 935 stores the number of relation lines in the relation diagram. There are as many relation line ID cells 940 as the number of relation lines indicated in the number-of-relation-lines cell 935 below the number-of-relation-lines cell 935. In the exemplary embodiment, the relation line ID cells 940 store information (relation line IDs) for uniquely identifying the relation lines. The information indicated by the relation line IDs is stored in a relation line information table 1100.

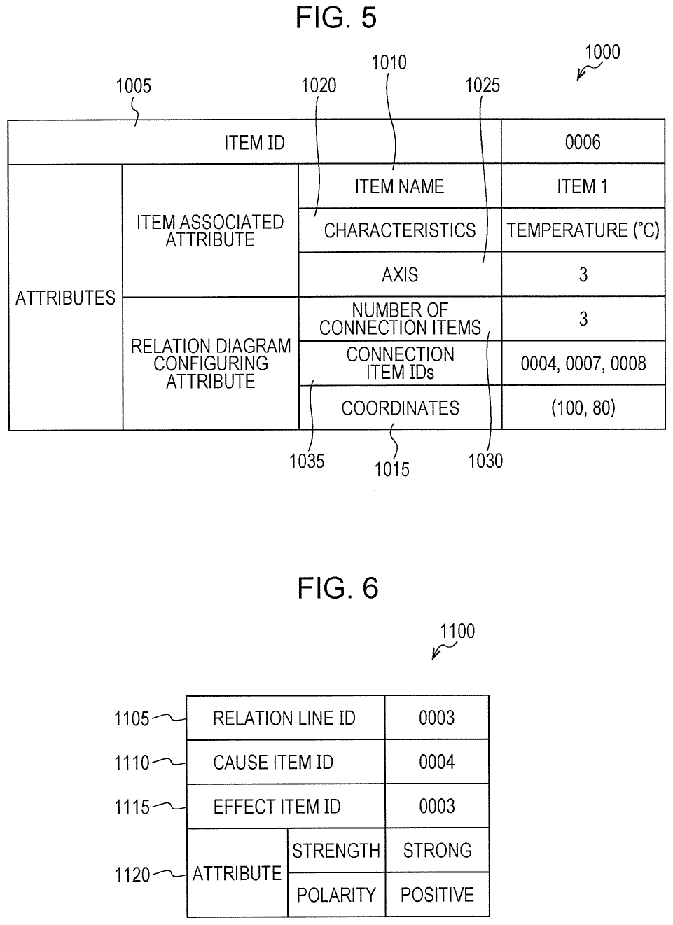

FIG. 5 illustrates a data structure example of the item information table 1000. The item information table 1000 is prepared for each item ID and includes, as attributes, an item associated attribute that is an attribute associated with an item and a relation diagram configuring attribute that is an attribute for configuring a relation diagram. The item associated attribute is attributes such as a name of an item, characteristics, and an axis to which the item belongs. Note that the characteristics herein include a nature, a behavior, and an effect. The relation diagram configuring attribute is attributes such as the number of connection items, connection item IDs, and coordinates. Along with the relation diagram configuring attribute, the item information table 1000 includes an item ID cell 1005, an item name cell 1010, a coordinates cell 1015, a characteristics cell 1020, an axis cell 1025, a number-of-connection-items cell 1030, and a connection item ID cell 1035. The item ID cell 1005 stores an item ID. The item name cell 1010 stores a name of an item having the item ID. The coordinates cell 1015 stores coordinates at which the item is displayed in the relation diagram. The characteristics cell 1020 stores characteristics of the item. The axis cell 1025 stores an axis to which an axis item corresponding to the item belongs when the relation diagram is converted into a deployment chart. The number-of-connection-items cell 1030 stores the number of items to which the subject item is connected. That is, the number-of-connection-items cell 1030 stores the total number of items serving as destinations of the item as a source and items serving as sources of the item as a destination. The connection item ID cell 1035 stores as many connection item IDs as the number of items indicated in the number-of-connection-items cell 1030. The connection item ID cell 1035 stores IDs of items serving as destinations and items serving as sources.

FIG. 6 illustrates a data structure example of the relation line information table 1100. The relation line information table 1100 includes a relation line ID cell 1105, a source item ID cell 1110, a destination item ID cell 1115, and an attribute cell 1120. The relation line ID cell 1105 stores a relation line ID of a relation line. The source item ID cell 1110 stores an item ID of an item serving as a source for the relation line. The destination item ID cell 1115 stores an item ID of an item serving as a destination for the relation line. The attribute cell 1120 stores an attribute of the relation line. The attribute is, for example, a polarity of the relation line. The polarity is a nature regarding whether an increase in a numeric value of an item serving as a source increases a numeric value of an item serving as a destination (e.g., in direct proportion) or whether an increase in a numeric value of an item serving as a source decreases a numeric value of an item serving as a destination (e.g., in reverse proportion). Also, the attribute is, for example, the strength of a degree of a relation indicated by the relation line or the direction of a relation indicated by the relation line.

Note that the tables illustrated in FIGS. 4 to 6 are examples, and other data structures may alternatively be used. For example, the data structure of a graph may be used.

The generation unit 102 is capable of generating a relation diagram visually representing dependence relations between items by using data stored in the tables illustrated in FIGS. 4 to 6. In addition, the generation unit 102 is also capable of extracting words or phrases related to the keyword received by the reception unit 101 by referring to data stored in the tables illustrated in FIGS. 4 to 6.

The information about a relation diagram is not necessarily stored in the storage unit 105. The information about a relation diagram may be stored in an apparatus other than the server 10.

The server 10 according to the exemplary embodiment has the configuration illustrate in FIG. 3 and thus may present information for supporting conception of items representing events to be arranged in a relation diagram even in a case where a user is inexperienced in generating a relation diagram when the user tries to generate a relation diagram.

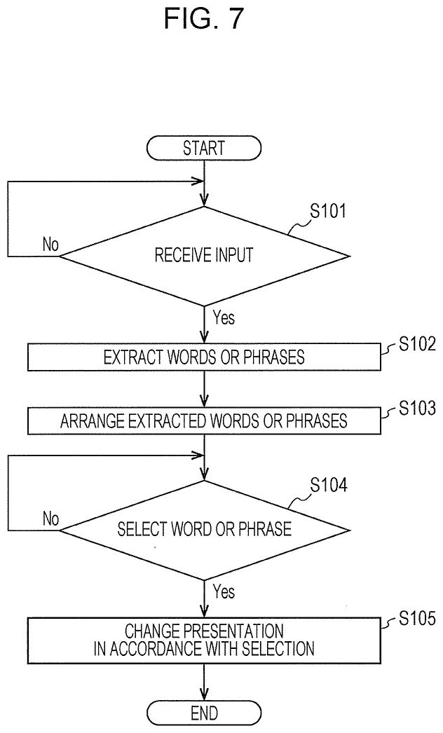

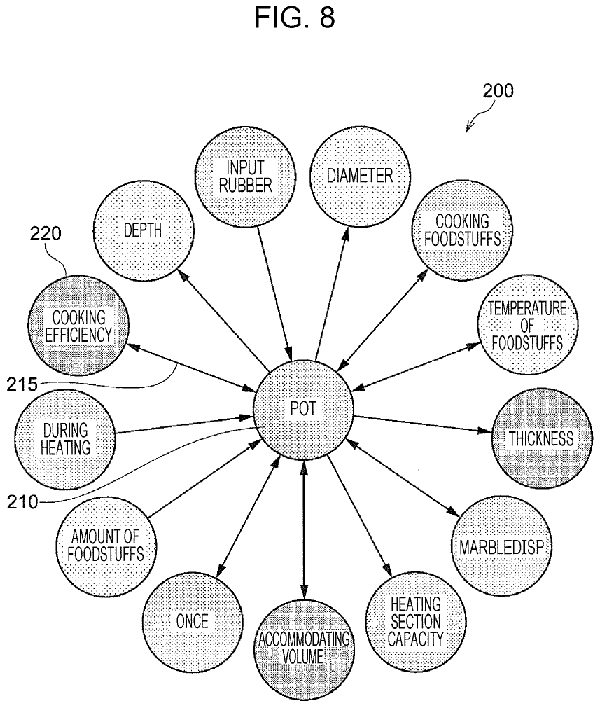

Next, operations of the server 10 will be described. FIG. 7 is a flowchart illustrating a flow of a words or phrases presenting process performed by the server 10. The words or phrases presenting process is performed by the CPU 11 reading a words or phrases presenting program from the ROM 12 or the storage 14 and loading and executing the program in the RAM 13.

In a state where a user interface for presenting words or phrases related to a keyword to be input from a user terminal 20 is presented on the user terminal 20, the CPU 11 waits until receiving input of a keyword from the user terminal 20 (step S101). Upon reception of input of the keyword from the user terminal 20 (step S101; Yes), the CPU 11 extracts words or phrases related to the input keyword on the basis of a relation diagram generated in the past or information about the keyword (step S102). An upper limit may be set for the number of extracted words or phrases. In a case where words or phrases are extracted on the basis of the relation diagram generated in the past, the CPU 11 extracts the words or phrases by referring to the relation diagram information table 900, the item information table 1000, and the relation line information table 1100.

It is assumed that a user inputs “pot” as a keyword. The CPU 11 extracts, from the item information table 1000, names of items including “pot” or names of items having relations with the items including “pot”.

Subsequently to step S102, on the user interface, the CPU 11 arranges and presents the words or phrases extracted in step S102 around the keyword input from the user terminal 20 (step S103). When arranging and presenting the words or phrases, for example, the CPU 11 may depict circles around the keyword and the words or phrases and link the circle for the keyword and the circles for the words or phrases via lines. In addition, when arranging and presenting the words or phrases, the CPU 11 may explicitly indicate intensions for the extracted words or phrases.

Subsequently to step S103, the CPU 11 determines whether a user selects on the user interface any of the words or phrases presented on the user interface in step S103 (step S104). The CPU 11 waits until the user selects on the user interface any of the words or phrases presented on the user interface (step S104; No). Upon any of the words or phrases presented on the user interface being selected by the user on the user interface (step S104; Yes), the CPU 11 changes presentation of the words or phrases on the user interface in accordance with the selected word or phrase (step S105).

The flow illustrated in FIG. 7 will be described by using specific content presented on the user interface presented by the server 10 on the user terminal 20.

FIG. 8 illustrates an example of the user interface presented by the server 10 on the user terminal 20. FIG. 8 illustrates an example of a user interface 200 presented by the server 10 on the user terminal 20 when a user inputs the keyword “pot” to the user terminal 20.

Upon input of the keyword “pot” being received from the user terminal 20, the CPU 11 extracts words or phrases related to “pot” on the basis of a relation diagram generated in the past or information about the keyword. On the user interface 200, a circle 210 surrounding the keyword input by the user and circles 220 surrounding the words or phrases extracted by the CPU 11 are presented.

In the example illustrated in FIG. 8, as words or phrases related to “pot”, the CPU 11 extracts words or phrases “input rubber”, “diameter”, “cooking foodstuffs”, “temperature of foodstuffs”, “thickness”, “MarbleDisp”, “heating section capacity”, “accommodating volume”, “once”, “amount of foodstuffs”, “during heating”, “cooking efficiency”, and “depth”. Then, the CPU 11 arranges and presents these extracted words or phrases around “pot” on the user interface 200.

When arranging the extracted words or phrases, as illustrated in FIG. 8, the CPU 11 may link the circle 210 for the keyword input from the user terminal 20 and the circles 220 for the extracted words or phrases via lines 215. As illustrated in FIG. 8, the lines 215 may be arrows. The arrow means a superordinate or subordinate relation with the keyword at the center.

When presenting the extracted words or phrases on the user interface 200, the CPU 11 explicitly indicates the reasons for the extracted words or phrases. In the example in FIG. 8, “thickness”, “accommodating volume”, and “cooking efficiency” are extracted by the CPU 11 from information about the keyword “pot”, as words or phrases that have been placed after the keyword “pot” in the past. In addition, in the example in FIG. 8, “input rubber”, “cooking foodstuffs”, “MarbleDisp”, “heating section capacity”, “once”, and “during heating” are extracted by the CPU 11 from information about the keyword “pot”, as words or phrases that are related to “pot”. Furthermore, in the example in FIG. 8, “diameter”, “temperature of foodstuffs”, “amount of foodstuffs”, and “depth” are extracted by the CPU 11 from a relation diagram generated in the past, as words or phrases that are possibly branches from “pot”.

The CPU 11 presents the extracted words or phrases related to “pot” in different manners depending on the reasons for extraction. For example, the CPU 11 may present the extracted words or phrases related to “pot” by using different colors or patterns in accordance with the reasons for extraction on the background of the circles surrounding the words or phrases. For example, the CPU 11 may set a blue background for the circles surrounding the words or phrases that have been placed after the keyword “pot” in the past, a green background for the circles surrounding the words or phrases that are extracted as being related to “pot”, and a red background for the circles surrounding the words or phrases that are extracted as possibly being branches from “pot”.

In addition, for example, the CPU 11 may present the extracted words or phrases related to “pot” by surrounding the words or phrases with different shapes depending on the reasons for extraction. For example, the CPU 11 may surround the words or phrases that have been placed after the keyword “pot” in the past with circles, surround the words or phrases that are extracted as being related to “pot” with squares, and surround the words or phrases that are extracted as possibly being branches from “pot” with tringles.

By viewing the user interface 200 presented on the user terminal 20, a user is able to conceive items representing events to be arranged in a relation diagram when generating the relation diagram. First, if a user selects any one of the words or phrases arranged on the user interface 200, a branch starts from the selected word or phrase in the relation diagram. Subsequently, if a user selects another one of the words or phrases arranged on the user interface 200, the CPU 11 presents, on the user interface 200, candidate words or phrases that are appropriate to be arranged in the same layer as the selected word or phrase in the relation diagram to be distinguishable from the rest of the words or phrases.

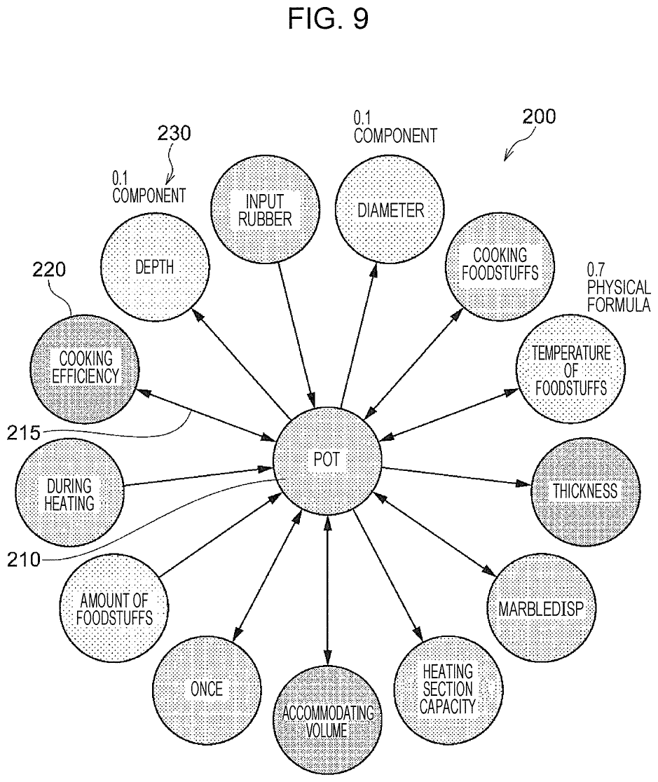

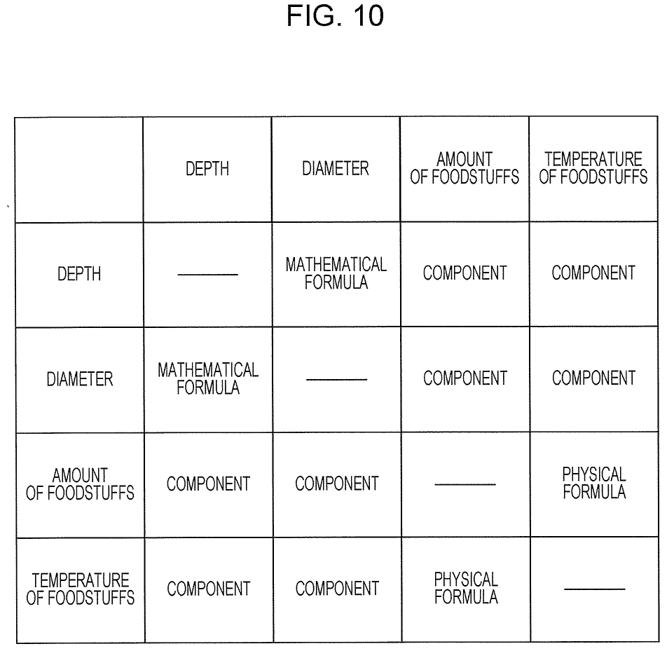

FIG. 9 illustrates an example of the user interface presented by the server 10 on the user terminal 20. In the example of the user interface 200 illustrated in FIG. 9, a user selects the phrase “amount of foodstuffs” on the user interface 200. Note that in FIG. 9, first, a user selects “cooking efficiency” from among the words or phrases arranged on the user interface 200. That is, the CPU 11 presents, on the user interface 200, candidate words or phrases from which a branch of “cooking efficiency of pot” starts.

Upon the user selecting “amount of foodstuffs” on the user interface 200, the CPU 11 selects, from among the words or phrases from which a branch of “cooking efficiency of pot” may start, “diameter”, “temperature of foodstuffs”, and “depth” as candidate words or phrases. Then, for the candidate words or phrases “diameter”, “temperature of foodstuffs”, and “depth”, the CPU 11 calculates scores according to a predetermined algorithm. The CPU 11 calculates the scores by using an ontology regarding the keyword generated from an existing relation diagram, document data, or the like. For example, the CPU 11 may calculate the scores on the basis of relations between the selected word or phrase and the words or phrases from which a branch may start. In addition, as illustrated by reference numeral 230 in FIG. 9, the CPU 11 may present the scores calculated for “diameter”, “temperature of foodstuffs”, and “depth” and relations between the respective words or phrases and the word or phrase selected by the user on the user interface 200.

FIG. 10 illustrates an example of information to be used by the CPU 11 to calculate the scores. FIG. 10 illustrates relations between each of four words or phrases, “depth”, “diameter”, “amount of foodstuffs”, and “temperature of foodstuffs” with other words or phrases.

An example of “depth” will be described. “Depth” and “diameter” are in a relation of a mathematical formula because a mathematical formula for obtaining the capacity of a pot may be obtained from the depth of the pot and the diameter of the pot. “Depth” and each of “amount of foodstuffs” and “temperature of foodstuffs” are simply in a relation of a component because characteristics concerning the pot are not obtained from the depth of the pot and the amount of foodstuffs or the temperature of foodstuffs

Similarly, an example of “amount of foodstuffs” will be described. “Amount of foodstuffs” and “temperature of foodstuffs” are in a relation of a physical formula because the amount of foodstuffs in the pot is related to the temperature of foodstuffs in the pot. “Amount of foodstuffs” and each of “depth” and “diameter” are in a relation of a component because characteristics concerning the pot are not obtained from the amount of foodstuffs and the depth of the pot or the diameter of the pot.

In the example illustrated in FIG. 9, as a result of calculation of the scores performed by the CPU 11 according to the predetermined algorithm, when “amount of foodstuffs” is selected, the score of “temperature of foodstuffs” is 0.7, and the score of each of “diameter” and “depth” is 0.1. Note that the total score may not be equal to 1 for the following reason. Referring to FIG. 10, “amount of foodstuffs” and each of “depth” and “diameter” are in a relation of a component, whereas “amount of foodstuffs” and “temperature of foodstuffs” are in a relation of a physical formula. Thus, “temperature of foodstuffs”, which has the higher score, is appropriate to be arranged in the same layer as “amount of foodstuffs”.

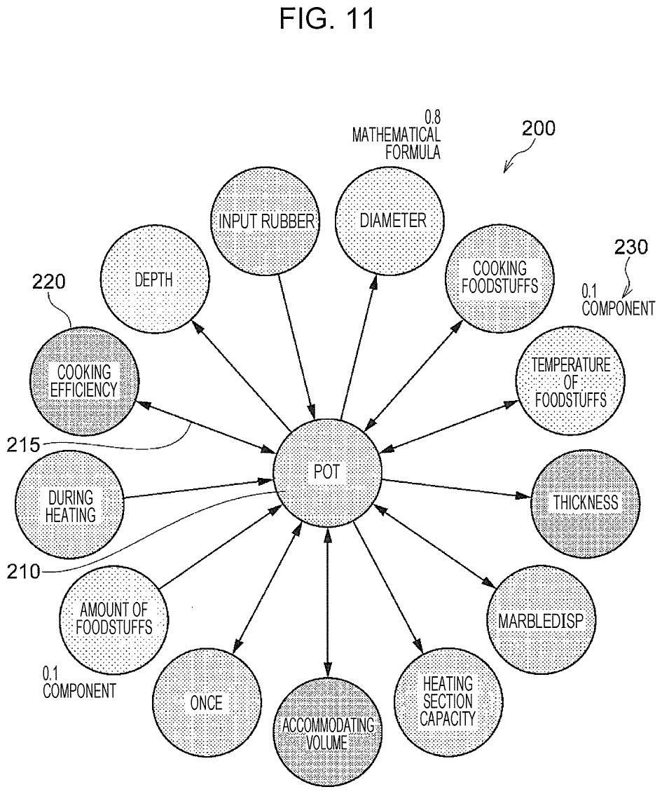

FIG. 11 illustrates an example of the user interface presented by the server 10 on the user terminal 20. FIG. 11 illustrates an example of the user interface 200 in a case where a user selects the word “depth” on the user interface 200. Referring to FIG. 11, “depth” and each of “amount of foodstuffs” and “temperature of foodstuffs” are in a relation of a component. On the other hand, referring to FIG. 11, “depth” and “diameter” are in a relation of a mathematical formula because the depth of the pot and the diameter of the pot are related to the capacity of the pot. Thus, “diameter”, which has the higher score, is appropriate to be arranged in the same layer as “depth”.

In the above manner, by arranging words or phrases having high scores in the same layer as the selected word or phrase, even in a case where a user is inexperienced in generating a relation diagram, the user is able to generate a relation diagram illustrating effects and their causes in detail without any missing or overlapping item. Thus, even in a case where a user is inexperienced in generating a relation diagram, the server 10 according to the exemplary embodiment is capable of presenting, to the user, information for supporting conception of items representing events to be arranged in a relation diagram.

When one of the presented words or phrases is selected, the CPU 11 may set the selected word or phrase as a keyword and may further extract and present words or phrases related to the keyword on the user interface. For example, in the example of the user interface 200 illustrated in FIG. 8, a user selects “temperature of foodstuffs” and instructs the server 10 to extract words or phrases related to “temperature of foodstuffs”. The server 10 may similarly extract words or phrases related to “temperature of foodstuffs” and may present the extracted words or phrases on the user interface 200.

Although the scores are presented on the user interface 200 in response to selection of a word or phrase by a user in FIG. 9 and FIG. 11, the present disclosure is not limited to these examples. For example, the CPU 11 may present candidate words or phrases in an emphasized manner in response to selection of a word or phrase by a user. Although the candidate words or phrases may be emphasized by various methods, for example, the CPU 11 may present the candidate words or phrases by increasing the thickness of lines of circles that surround the candidate words or phrases in response selection of a word or phrase by a user.

For example, the CPU 11 may alternatively calculate the scores in response to selection of a word or phrase by a user and may change the size of figures that surround the words or phrases in accordance with the calculated scores. In a case where the extracted words or phrases are surrounded by circles, the CPU 11 may present the circles by increasing the diameters thereof on the user interface 200 in accordance with the magnitude of the scores calculated in response to selection of a word or phrase by a user. In addition, for example, the CPU 11 may alternatively calculate the scores in response to selection of a word or phrase by a user and may change the distance between the input keyword and the extracted words or phrases in accordance with the calculated scores. The CPU 11 may present the extracted words or phrases on the user interface 200 by setting a shorter distance between the keyword and the extracted words or phrases as the calculated scores are higher.

By presenting the user interface 200 to the user terminal 20, the server 10 according to the exemplary embodiment may represent the words or phrases related to the input keyword to the user and present candidate words or phrases that are appropriate to be arranged in the same layer as the selected word or phrase in a relation diagram. By referring to the user interface 200 presented on the user terminal 20, the user is able to proceed generation of a relation diagram. In addition, by presenting words or phrases related to the input keyword the user interface 200, the server 10 according to the exemplary embodiment may reduce the possibility of occurrence of a missing item compared with a case where no words or phrases are presented when a user generates a relation diagram.

Although the exemplary embodiment describes a case where the program for the words or phrases presenting process is stored (installed) in the ROM or the storage in advance. However, the disclosure is not limited to this. The program may be provided by being stored in a storage medium such as a Compact Disk Read Only Memory (CD-ROM), a Digital Versatile Disk Read Only Memory (DVD-ROM), or a Universal Serial Bus (USB) memory. Alternatively, the program may be downloaded via a network from an external apparatus.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
receive input of a given keyword, and
arrange and present a plurality of words or phrases around the keyword, the words or phrases being related to the keyword, on the basis of content indicated by an existing relation diagram or information about the keyword, the relation diagram including a plurality of items having relations and being generated in advance by systematically connecting the items.

2. The information processing apparatus according to claim 1,
wherein, when one word or phrase is selected from among the plurality of words or phrases, the processor presents a candidate word or phrase that is appropriate to be arranged in the same layer as the selected word or phrase in a relation diagram to be edited, to be distinguishable from the rest of the plurality of words or phrases.

3. The information processing apparatus according to claim 2,
wherein, when one word or phrase is selected from among the plurality of words or phrases, the processor calculates a score for the candidate word or phrase and presents the score in association with the candidate word or phrase.

4. The information processing apparatus according to claim 3,
wherein the processor calculates the score on the basis of the content of the existing relation diagram.

5. The information processing apparatus according to claim 2,
wherein the processor presents the plurality of words or phrases by surrounding each of the words or phrases with a frame, and
when one word or phrase is selected from among the plurality of words or phrases, the processor increases a diameter of the frame surrounding the candidate word or phrase to be larger than the frames surrounding the rest of the plurality of words or phrases.

6. The information processing apparatus according to claim 5,
wherein, when one word or phrase is selected from among the plurality of words or phrases, the processor calculates a score for the candidate word or phrase and sets a size of the frame surrounding the candidate word or phrase in accordance with the calculated score.

7. The information processing apparatus according to claim 2,
wherein, when one word or phrase is selected from among the plurality of words or phrases, the processor presents the candidate word or phrase in an emphasized manner.

8. The information processing apparatus according to claim 1,
wherein the processor presents the plurality of words or phrases by linking the keyword and each of the plurality of words or phrases via a line and representing an order relation between the keyword and each of the plurality of words or phrases by using an arrow.

9. The information processing apparatus according to claim 1,
wherein the processor extracts a word or phrase related to the keyword in the existing relation diagram and arranges and presents the extracted word or phrase around the keyword.

10. The information processing apparatus according to claim 9,
wherein the processor presents the word or phrase related to the keyword in the existing relation diagram to be distinguishable from a word or phrase obtained from the information about the keyword.

11. A non-transitory computer readable medium storing a program causing a computer to execute a process for information processing, the process comprising:
receiving input of a given keyword; and
arranging and presenting a plurality of words or phrases around the keyword, the words or phrases being related to the keyword, on the basis of content indicated by an existing relation diagram or information about the keyword, the relation diagram including a plurality of items having relations and being generated in advance by systematically connecting the items.

12. An information processing apparatus comprising:
processing means for: receiving input of a given keyword; and arranging and presenting a plurality of words or phrases around the keyword, the words or phrases being related to the keyword, on the basis of content indicated by an existing relation diagram or information about the keyword, the relation diagram including a plurality of items having relations and being generated in advance by systematically connecting the items.
